(19) United States
(12) Patent Application Publication
(10) Pub. No.: US 2017/0164061 A1
(43) Pub. Date: Jun. 8, 2017

(54) METHOD AND DEVICE FOR CONTROLLING PROGRAM BROADCASTING OF TELEVISION EQUIPMENT

(71) Applicants: LE HOLDINGS (BEIJING) CO., LTD., Beijing (CN); LE SHI ZHI XIN ELECTRONIC TECHNOLOGY (TIANJIN) LIMITED, Tianjin (CN)

(72) Inventor: Pengfei LI, Tianjin (CN)

(21) Appl. No.: 15/249,328

(22) Filed: Aug. 26, 2016

Related U.S. Application Data
(63) Continuation of application No. PCT/CN2016/089260, filed on Jul. 7, 2016.

(30) Foreign Application Priority Data
Dec. 4, 2015 (CN) 201510885491.7

(51) Int. Cl. H04N 21/482; H04N 21/436; H04N 21/414; H04N 21/435; H04N 21/845; H04N 21/81; H04N 21/422; H04N 21/472

(52) U.S. Cl. CPC H04N 21/4826; H04N 21/4821; H04N 21/42204; H04N 21/436; H04N 21/47202; H04N 21/435; H04N 21/845; H04N 21/8133; H04N 21/41407

(57) ABSTRACT

Disclosed are a method and a device for controlling and broadcasting programs of television equipment to solve the problem that random and accidental cases cannot be analyzed. The control method comprises the following steps: acquiring by the mobile equipment a program list corresponding to a carousel-broadcasting program assembly from a server, wherein the carousel-broadcasting program assembly comprises programs that are carousel-broadcast in a set time slot; displaying respective carousel-broadcasting programs in the carousel-broadcasting program assembly in categories according to the program list; acquiring the carousel-broadcasting programs of a selected program category and program information of the carousel-broadcasting programs according to a first selection instruction; and sending the program information of the carousel-broadcasting programs to connected television equipment so as to control the television equipment to broadcast the carousel-broadcasting programs. Functions of a mobile phone-based remote controller are enriched and meanwhile program selection operations are simplified.

### CROSS-REFERENCE TO RELATED APPLICATIONS

The present disclosure is a continuation of International Application No. PCT/CN2016/089260 filed on Jul. 7, 2016, which is based upon and claims priority to Chinese Patent Application No. 201510885491.7, entitled “METHOD AND DEVICE FOR CONTROLLING PROGRAM BROADCASTING OF TELEVISION EQUIPMENT”, filed Dec. 4, 2015, the entire contents of all of which are incorporated herein by reference.

### TECHNICAL FIELD

The present disclosure generally relates to the technical field of mobile Internet, in particular to a method and a device for controlling program broadcasting of television equipment.

### BACKGROUND

With the development of the Internet, the mobile phone is a kind of handheld communication equipment that is most frequently used by people at present, and people are used to carrying mobile phones with them everywhere and putting their mobile phones nearby frequently. Therefore, many people hope that mobile phones can also be used as remote controllers for televisions. At present, software and hardware of smart phones are very powerful, touch screens of large dimension can be designed as controllers of various keyboard layouts, so that the smart phones can be used as the remote controllers for televisions as long as appropriate software is matched with small accessories. Current mobile phone-based remote controllers only have a remote controlling function of conventional remote controllers, quite a single function.

As a novel product formed based on the impact of Internet boom, smart television aims at bringing users a more convenient experience, and has become a trend of televisions at present. Smart televisions provide users a huge number of online video resources, and the users can select their favorite video programs in an on-demand manner. However, due to the single function of the mobile phone-based remote controllers, people face with complicated selection operations although the on-demand function of the smart televisions gives people the right to select on their own.

### SUMMARY

An embodiment of the present disclosure discloses a method and a device for controlling program broadcasting of television equipment to solve the problem that random and accidental cases cannot be analyzed.

To solve the problem above, an embodiment of the present disclosure discloses a method for controlling program broadcasting of television equipment, the method being applied to mobile equipment, wherein the method includes the following steps: acquiring by the mobile equipment a program list corresponding to a carousel-broadcasting program assembly from a server, wherein the carousel-broadcasting program assembly includes programs that are carousel-broadcast in a set time slot; displaying respective carousel-broadcasting programs in the carousel-broadcasting program assembly in categories according to the program list; acquiring the carousel-broadcasting programs of a selected program category and program information of the carousel-broadcasting programs according to a first selection instruction; and sending the program information of the carousel-broadcasting programs to connected television equipment so as to control the television equipment to broadcast the carousel-broadcasting programs.

Correspondingly, an embodiment of the present disclosure discloses a method for controlling program broadcasting of television equipment, the method being applied to the television equipment, wherein the method includes the following steps: receiving program information of carousel-broadcasting programs that is sent by connected mobile equipment, wherein the program information is selected after the mobile equipment displays a program list corresponding to a carousel-broadcasting program assembly in categories; determining whether to support a carousel-broadcasting station function according to the program information; broadcasting the program information to a carousel-broadcasting station application for the broadcasting of the carousel-broadcasting programs when the carousel-broadcasting station function is supported; and activating a player to broadcast the carousel-broadcasting programs corresponding to the program information when the carousel-broadcasting station function is not supported.

Correspondingly, an embodiment of the present disclosure discloses an electronic device for controlling program broadcasting of television equipment, including at least one first processor; and a first memory communicably connected with the at least one first processor for storing instructions executable by the at least one first processor, wherein execution of the instructions by the at least one first processor causes the at least one first processor to: acquire a program list corresponding to a carousel-broadcasting program assembly from a server, wherein the carousel-broadcasting program assembly includes programs that are carousel-broadcast in a set time slot; display respective carousel-broadcasting programs in the carousel-broadcasting program assembly in categories according to the program list; acquire the carousel-broadcasting programs of a selected program category and program information of the carousel-broadcasting programs according to a first selection instruction; and send the program information of the carousel-broadcasting programs to connected television equipment so as to control the television equipment to broadcast the carousel-broadcasting programs.

Correspondingly, an embodiment of the present disclosure discloses an electronic device for broadcasting programs, wherein the electronic device includes at least one second processor; and a second memory communicably connected with the at least one second processor for storing instructions executable by the at least one second processor, wherein execution of the instructions by the at least one second processor causes the at least one second processor to: receive program information of carousel-broadcasting programs that are sent from connected mobile equipment, wherein the program information is selected after mobile equipment displays a program list corresponding to a carousel-broadcasting program assembly in categories; determine whether to support a carousel-broadcasting station function; broadcast the program information to a carousel-broadcasting station application for the broadcasting of the carousel-broadcasting programs when the carousel-broadcasting station function is supported; and activate a player to broadcast the carousel-broadcasting programs corresponding to the program information when the carousel-broadcasting station function is not supported.

An embodiment of the present disclosure discloses a computer program, including a computer readable code, wherein the computer readable code causes mobile equipment to execute the method above when operating on the mobile equipment.

An embodiment of the present disclosure discloses a computer readable medium, in which the computer program are stored.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a steps flow chart of a method for controlling program broadcasting of television equipment according to some embodiments of the present disclosure.

FIG. 2 is a steps flow chart of a method for controlling program broadcasting of television equipment according to some embodiments of the present disclosure.

FIG. 3 is a steps flow chart of a method for controlling program broadcasting of television equipment according to some embodiments of the present disclosure.

FIG. 4 is an operation effect diagram of entering a multi-terminal interaction application according to some embodiments of the present disclosure.

FIG. 5 is an operation effect diagram of entering a homepage according to some embodiments of the present disclosure.

FIG. 6 is a structural block diagram of a device for controlling program broadcasting of television equipment according to some embodiments of the present disclosure.

FIG. 7 is a structural block diagram of a device for controlling program broadcasting of television equipment according to some embodiments of the present disclosure.

FIG. 8 is a structural block diagram of a device for broadcasting programs of television equipment according to some embodiments of the present disclosure.

FIG. 9 schematically illustrates a block diagram of an electronic device used to execute the method according to some embodiments of the present disclosure.

FIG. 10 schematically illustrates a memory cell used to keep or carry a program code for realizing the method according to some embodiments of the present disclosure.

### DETAILED DESCRIPTION

In order to clarify the objects, technical solutions and advantages of the embodiments of the present disclosure, the technical solutions in the embodiments of the present disclosure will be described in a clearly and fully understandable way in connection with the drawings related to the embodiments of the present disclosure. It is obvious that the described embodiments are just a part but not all of the embodiments of the present disclosure. Based on the described embodiments herein, a person skilled in the art can obtain other embodiment(s), without any creative work, which should be within the scope of the present disclosure.

According to an embodiment of the present disclosure, one of core conceptions is to disclose a method and a device for controlling program broadcasting of television equipment to solve the problem that random and accidental cases cannot be analyzed. A program list corresponding to a carousel-broadcasting program assembly is acquired from a server through mobile equipment, carousel-broadcasting programs are displayed in categories according to the program list, a carousel-broadcasting program and program information in a designated category are acquired according to a first selection instruction, and the program information is sent to connected television equipment so as to control the television equipment to broadcast the carousel-broadcasting program. Therefore, functions of a mobile phone-based remote controller are enriched, program selection operations are simplified, and an on-demand function of a smart television is more perfect.

### Embodiment One

A method for controlling program broadcasting of television equipment through mobile equipment according to the embodiment of the present disclosure will be described in detail.

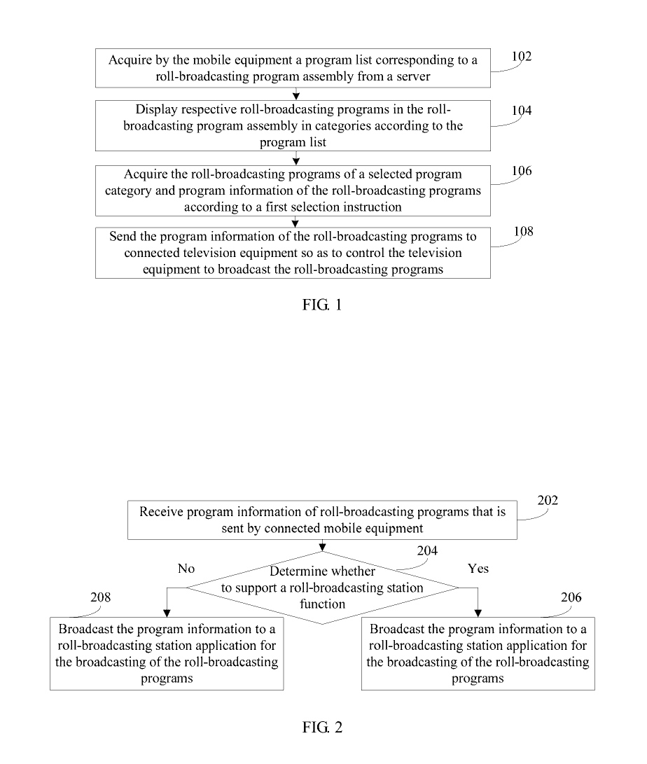

With reference to FIG. 1, which illustrates a step flow chart of a method for controlling program broadcasting of television equipment according to an embodiment of the present disclosure, the method may specifically including the steps as follows.

Step S102 in that the mobile equipment acquires a program list corresponding to a carousel-broadcasting program assembly from a server, wherein the carousel-broadcasting program assembly includes programs that are carousel-broadcast in a set time slot.

The mobile equipment includes a mobile phone and a tablet computer. Current mobile equipment as remote controllers only has a remote control function, quite a single function. However, the server provides users a huge number of online video resources, a user need to check video programs one by one for the on-demand selection of a favorite video program at present, so that the operation is fairly cumbersome. As user's requirements become higher and higher, the users not only hope that mobile phone-based remote controllers have the single remote control function of the conventional remote controllers, but also hope that the mobile phone-based remote controllers can bear more functions in connection with television content resources, so as to bring more convenience for the users to control the program broadcasting of the television equipment through the mobile equipment.

The mobile equipment sends to the server a request to establish a connection, and acquires the program list corresponding to the carousel-broadcasting program assembly from the server after the connection is established. The carousel-broadcasting program assembly includes the programs that are selected from a video database and are carousel-broadcast in a set time slot. For example, the selected programs can be watched in advance within 24 hours, and missed programs can be watched by return. The carousel-broadcasting programs that are selected from the server are of a great variety and a huge number, the server will classify the huge number of carousel-broadcasting programs, and the carousel-broadcasting programs in different categories are recorded through the program list.

Step S104, displaying the respective carousel-broadcasting programs in the carousel-broadcasting program assembly in categories according to the program list.

At present, the user needs to check the video programs one by one for the on-demand selection of the favorite video program, so that the operation is fairly cumbersome. However, according to the present disclosure, the different categories and corresponding carousel-broadcasting programs are displayed in combination by acquiring the program list of the carousel-broadcasting programs that are recorded in different categories. When selecting the favorite video program, the user can select the category that the program belongs to at first, and then go to the carousel-broadcasting programs corresponding to the category for the on-demand selection of the favorite video program, so that the operation is quite simple.

Step S106, acquiring the carousel-broadcasting programs of the selected program category and program information of the carousel-broadcasting programs according to a first selection instruction.

When the user selects the favorite video program in an on-demand manner, the first selection instruction is triggered. The instruction herein refers to an indication and an order to command a machine, namely the mobile equipment, to work, and the mobile equipment acquires the selected program and the program information of the selected program according to the first selection instruction.

Step S108, sending the program information of the carousel-broadcasting programs to connected television equipment so as to control the television equipment to broadcast the carousel-broadcasting programs.

It is required to establish a connected between the mobile equipment and the television equipment when the mobile equipment sends the program information of the carousel-broadcasting programs to the television equipment. In general, the mobile equipment can establish the connection with the television equipment in the same local area network. The mobile equipment selects the television equipment from the local area network, and sends the request to establish the connection. After establishing the connection with the television equipment, the mobile equipment sends the program information of the carousel-broadcasting programs to the connected television equipment; the connected television equipment broadcasts the carousel-broadcasting programs according to the program information after receiving the program information; and therefore the television equipment can be controlled directly through the mobile phone.

In conclusion, the program list corresponding to the carousel-broadcasting program assembly is acquired from the server through the mobile equipment, the carousel-broadcasting programs are displayed in categories according to the program list, the carousel-broadcasting programs and the program information thereof in the designated category are acquired according to the first selection instruction, and the program information is sent to the connected television equipment so as to control the television equipment to broadcast the carousel-broadcasting programs, and therefore program selection operations are simplified, and control efficiency is increased.

The embodiment of the present disclosure can be applied to a television control system, and the television control system includes the server, the mobile equipment and the television equipment. The television equipment is controlled through the mobile equipment, wherein the mobile equipment is such as the mobile phone, the tablet computer and the like, and the television equipment is such as a smart television, a set top box and the like. A multi-terminal interaction application can be installed in the mobile equipment and the television equipment respectively, and the interaction between the mobile equipment and the television equipment can be realized based on the multi-terminal interaction applications. The respective multi-terminal interaction applications of the mobile equipment and the television equipment can be interacted with the server to acquire corresponding content.

Wherein, the multi-terminal interaction application at the mobile equipment can be interacted with the server to acquire various information of a television, and can also be interacted with the multi-terminal interaction application at the television equipment to control the television equipment. Namely, the multi-terminal interaction application is used to realize data interaction between different terminals, such as a “multi-screen have a look” application, smart remote control application and the like.

Therefore, the television equipment will broadcast the programs after receiving the program information of the mobile terminal, and the specific steps are described herein below:

With reference to FIG. 2, which illustrates a steps flow chart of a method for controlling program broadcasting of television equipment according to another embodiment of the present disclosure.

Step S202 of receiving the program information of the carousel-broadcasting programs that is sent by the mobile equipment.

Wherein, the program information is selected after the mobile equipment displays the program list corresponding to the carousel-broadcasting program assembly in categories. Namely, after acquiring the program list corresponding to the carousel-broadcasting program assembly from the server, the mobile equipment displays the respective carousel-broadcasting programs in the carousel-broadcasting program assembly in categories according to the program list, selects the carousel-broadcasting programs, and sends the program information of the carousel-broadcasting programs to the television equipment; and the television equipment correspondingly receives the program information of the carousel-broadcasting programs, wherein the television equipment and the mobile equipment establish a connection relationship, and the connection relationship may be initiatively established by the mobile equipment (for example the connection is realized by selecting the television equipment from the local area network) or established through the interaction of the television equipment and the mobile equipment.

Step S204, determining whether to support a carousel-broadcasting station function according to the program information.

The television equipment determines whether to support the carousel-broadcasting station function, namely whether the television equipment has a carousel-broadcasting station application, according to the program information of the carousel-broadcasting programs.

If yes, namely the television equipment supports the carousel-broadcasting station function, execute step S206; if not, namely the television equipment does not support the carousel-broadcasting station function, execute step S208.

Step S206, broadcasting the program information to the carousel-broadcasting station application to broadcast the carousel-broadcasting programs.

When it is determined whether the television equipment supports the carousel-broadcasting station function, the program information is broadcast to the carousel-broadcasting station application, and the carousel-broadcasting programs are broadcast by the carousel-broadcasting station application according to the program information.

Step S208, broadcasting the program information to the carousel-broadcasting station application for the broadcasting of the carousel-broadcasting programs.

When the carousel-broadcasting station function is not supported, a player is activated to broadcast the carousel-broadcasting programs corresponding to the program information.

When it is determined that the television equipment does not support the carousel-broadcasting station function, the carousel-broadcasting station application cannot be employed directly to broadcast the video, and therefore the player can be activated, and is employed to acquire program data according to the program information for the broadcasting of the carousel-broadcasting programs.

In conclusion, after receiving the program information of the carousel-broadcasting programs from the mobile equipment, the television equipment broadcasts the program information to the carousel-broadcasting station application for the broadcasting of the carousel-broadcasting programs if the carousel-broadcasting station function is supported, and the player is also activated to broadcast the carousel-broadcasting programs corresponding to the program information if the carousel-broadcasting station function is not supported. Therefore, the broadcasting of the carousel-broadcasting programs can be ensured without needing the user to execute other operations, so that user's operations are simplified.

### Embodiment Two

Another method for controlling program broadcasting of television equipment through mobile equipment according to the embodiment of the present disclosure will be described in detail.

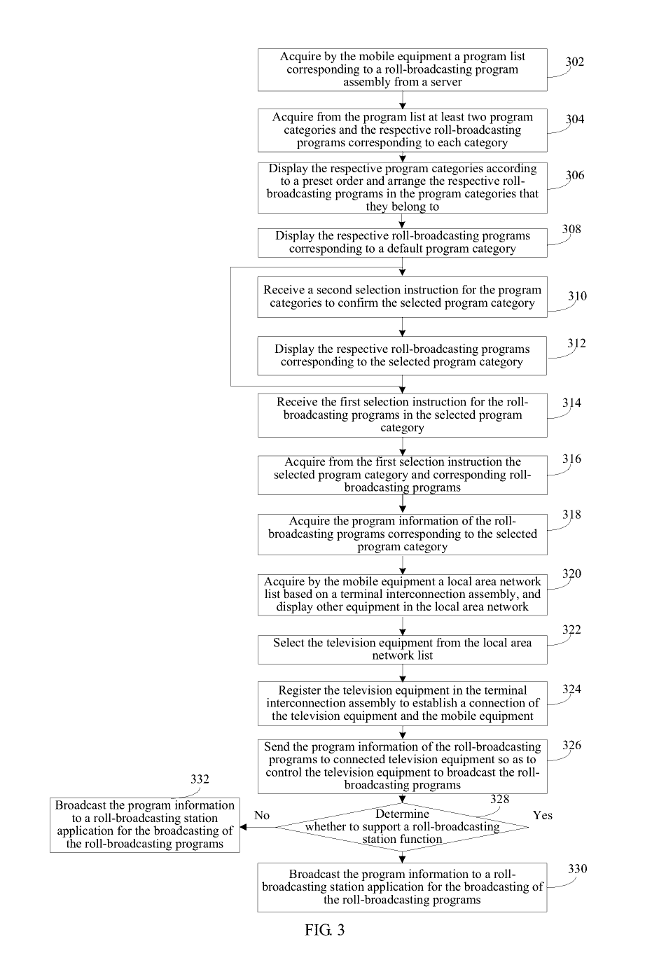

With reference to FIG. 3, which illustrates a steps flow chart of a method for controlling program broadcasting of television equipment according to a further embodiment of the present disclosure, the method may include the steps as follows.

Step S302, in that the mobile equipment acquires a program list corresponding to a carousel-broadcasting program assembly from a server, wherein the carousel-broadcasting program assembly includes programs that are carousel-broadcast in a set time slot.

The mobile equipment sends to the server a request to establish a connection through a multi-terminal interaction application, and acquires the program list corresponding to the carousel-broadcasting program assembly from the server after the connection is established. The carousel-broadcasting program assembly includes the programs that are selected from a video database and are carousel-broadcast in a set time slot. For example, the selected programs can be watched in advance within 24 hours, and missed programs can be watched by return. The carousel-broadcasting programs that are selected from the server are of a great variety and a huge number, the server will classify the huge number of carousel-broadcasting programs, and the carousel-broadcasting programs in different categories are recorded through the program list.

Step S304 that the mobile equipment acquires at least two program categories and respective carousel-broadcasting program corresponding to each category from the program list.

The carousel-broadcasting programs in different categories are recorded in the program list, and the carousel-broadcasting programs are of a great variety. At least two program categories and respective carousel-broadcasting program corresponding to each category are acquired from the program list. For example, the program category is “sports”, and the corresponding carousel-broadcasting programs include “World Youth Championship” and “Huang Jianxiang's Huang•Cross-Talk”; the program category is “TV series”, and the corresponding carousel-broadcasting programs include “My Love From the Star”, “Princess Pearl” and “Struggle”.

Step S306, in that the mobile equipment displays respective program categories according to a preset order and arranges the respective carousel-broadcasting programs in the program categories that they belong to.

For the convenience of a user to select a favorite program, a multi-terminal interaction application at the mobile equipment displays the respective program categories according to the preset order, for example in the order of initial letters of name phonations of the program categories for the convenience of the user to look for. As the respective carousel-broadcasting programs are arranged in the program categories that they belong to, the carousel-broadcasting programs in the program category that they belong to can be displayed when a certain category is clicked.

Step S308, displaying the respective carousel-broadcasting programs corresponding to a default program category.

In general, the multi-terminal interaction application at the mobile equipment will have the default program category, and therefore the default program category and the respective carousel-broadcasting programs corresponding to the default program category are displayed in a plurality of display manners when the user enters a homepage. For example, the respective categories are arranged at the top of the homepage, and the default program category such as “sports” is highlighted, and the respective carousel-broadcasting programs (such as the “World Youth Championship” and the “Huang Jianxiang's Huang•Cross-Talk”) corresponding to the default program category are displayed below the respective categories in the homepage in a transverse arrangement.

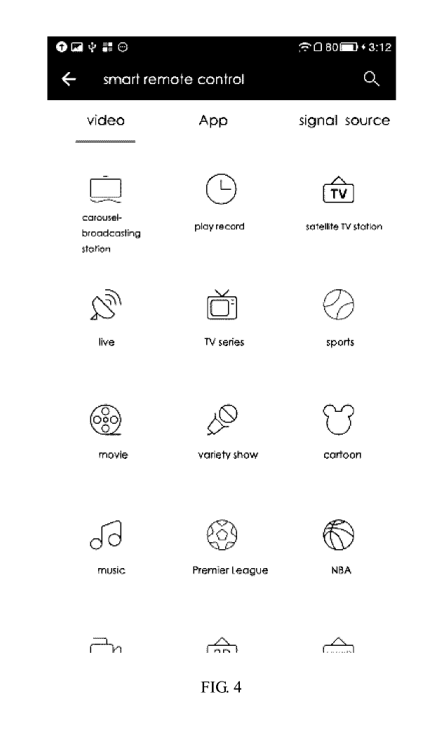

For example, as shown in FIG. 4 and FIG. 5, when the user enters the multi-terminal interaction application such as “smart remote control” and selects the carousel-broadcasting program assembly such as “carousel-broadcasting station” to enter the homepage, it can be seen that the default program category such as “sports” is highlighted, and the respective carousel-broadcasting programs (such as the “World Youth Championship” and the “Huang Jianxiang's Huang•Cross-Talk”) corresponding to the default program category are displayed below the respective categories in the homepage in a transverse arrangement.

Step S310, in that the mobile equipment receives a second selection instruction for the program categories and confirms a selected program categories.

Step S312, in that the mobile equipment displays the respective carousel-broadcasting programs corresponding to the selected program category.

When the user does not select the default program category of the multi-terminal interaction application at the mobile equipment, it is required to select other categories. When the user selects other categories, the multi-terminal interaction application at the mobile equipment receives the second selection instruction for the program categories and confirms the selected program category. The selected program category and the corresponding respective carousel-broadcasting programs are displayed in the homepage in a plurality of display manners. For example, the respective categories are arranged at the top of the homepage, and the default program category such as “TV series” is highlighted, and the respective carousel-broadcasting programs (such as the “My Love From the Star”, “Princess Pearl” and “Struggle”) corresponding to the default program category are displayed below the respective categories in the homepage in a transverse arrangement.

Step S314, in that the mobile equipment receives a first selection instruction for the carousel-broadcasting programs in the selected program category.

Step S316, in that the mobile equipment acquires the selected program category and the corresponding carousel-broadcasting programs from the first selection instruction.

Step S318, in that the mobile equipment acquires program information of the carousel-broadcasting programs corresponding to the selected program category.

Wherein, the program information includes a program name, a broadcasting address and/or description information.

The user selects the favorite video program for on-demand broadcasting, the multi-terminal interaction application at the mobile equipment receives the first selection instruction for the carousel-broadcasting programs in the selected program category, and acquires the program category of the selected program and corresponding carousel-broadcasting programs according to the first selection instruction, so as to acquire the program information of the selected program. The currently displayed program information includes the program name, the broadcasting address and/or the description information, wherein the program name refers to the name of a program, such as the name of a TV series or the name of a variety show and the like, for example “My Love From the Star” or “If You Are the One”; the broadcasting address refers to an address corresponding to a video source of the carousel-broadcasting programs, such as a video broadcasting address of a network program or a broadcasting channel for a television program, for example “http://www.letv.com/12345” or “CCTV-1 General Channel”; and the description information is used to introduce content of the currently displayed program information, including actors cast, plot summary and the like.

Step S320, in that the mobile equipment acquires a local area network list based on a terminal interconnection assembly, and displays other equipment in the local area network, wherein the other equipment includes the television equipment.

A plurality of equipment is connected in the local area network. Information (such as an equipment identification and the like) of the equipment can be saved in the local area network list, and the mobile equipment can acquire the local area network list based on the terminal interconnection assembly, so as to display all other equipment that is connected in the local area network, including the television equipment that is connected in the local area network, wherein the terminal interconnection assembly refers to an assembly that is generated based on a DLNA framework (Digital Living Network Alliance Framework) for the interconnection and intercommunication of a wireless network and a wired network of other equipment including the mobile equipment, the television equipment and the like, so that digital media and content services may see more sharing and increase. The terminal interconnection assembly follows a protocol that is regulated in the DLNA framework.

Step S322, in that the mobile equipment selects the television equipment from the local area network list.

The television equipment that the user needs to interact with is selected from the local area network list where all other equipment that is connected in the local area network is displayed.

S324, in that the mobile equipment registers the television equipment in the terminal interconnection assembly to establish a connection of the television equipment and the mobile equipment.

Only the other equipment such as the mobile equipment, the television equipment and the like that are registered in the terminal interconnection assembly can realize interconnection and intercommunication. The selected television equipment is registered in the terminal interconnection assembly, namely the selected television equipment receives the protocol that is regulated in the terminal interconnection assembly, so as to establish the connection of the television equipment and the mobile equipment.

Step S326, in that the mobile equipment sends the program information of the carousel-broadcasting programs to the connected television equipment to control the carousel-broadcasting programs that are broadcast by the television equipment.

After the mobile equipment establishes the connection with the selected television equipment, the program information of the carousel-broadcasting programs is sent to the connected television equipment through the multi-terminal interaction application, wherein the interaction of messages between the mobile equipment and the television equipment can be realized by broadcasting the messages, and therefore the connected mobile equipment generates a first broadcasting message. The first broadcasting message includes the program information of the carousel-broadcasting programs, and is sent by the terminal interconnection assembly. The television equipment correspondingly receives the first broadcasting message.

Step S328, in that the television equipment queries data in a database of a carousel-broadcasting station according to the program information to determine whether to support a carousel-broadcasting station function.

After receiving the program information, the connected television equipment reads the database corresponding to the carousel-broadcasting program assembly. The television equipment is determined whether to support the broadcasting function of a carousel-broadcasting station according to whether there is data in the database corresponding to the carousel-broadcasting program assembly.

If yes, namely there is data support the carousel-broadcasting station function, execute step S330; if not, namely there is no data to support the carousel-broadcasting station function, execute step S332.

Step S330, broadcasting the program information to a carousel-broadcasting station application for the broadcasting of the carousel-broadcasting programs.

The connected television equipment generates a second broadcasting message, and sends the second broadcasting message to the carousel-broadcasting station application. The carousel-broadcasting station application looks for broadcasting data of the carousel-broadcasting programs to broadcast the carousel-broadcasting programs according to the program information of the second broadcasting message.

Step S332, activating a player to broadcast the carousel-broadcasting programs corresponding to the program information.

When there is not data to support the carousel-broadcasting station function, the player can be activated. For example, a video player of the television equipment is activated through the multi-terminal interaction application such as a “multi-screen have a look” application at a television; and then the program information is sent to the player. The player confirms a broadcasting address of the program information and acquires broadcasting data from the broadcasting address for the broadcasting of the carousel-broadcasting programs.

In conclusion, the program list corresponding to the carousel-broadcasting program assembly is acquired from the server through the mobile equipment, at least two program categories and the respective carousel-broadcasting programs corresponding to each program category are acquired from the program list, the respective program categories are displayed according to a preset order, the respective carousel-broadcasting programs are arranged in the program categories that they belong to for the convenience of the user to look for the favorite program, and therefore program selection operations are simplified, and control efficiency is increased.

It should be noted that: for the purpose of brief description, method embodiments are described as the combination of a series of actions, but a person skilled in the art should know that the embodiments of the present disclosure are not limited to the order of the described actions, because some steps may be executed in other orders or at the same time according to the embodiments of the present disclosure. Furthermore, a person skilled in the art should also know that all the embodiments described in the specifications belong to preferable embodiments, and therefore related actions are not always necessary for the embodiments of the present disclosure.

### Embodiment Three

On the basis of the above embodiment, the embodiment further provides a device for controlling program broadcasting of television equipment.

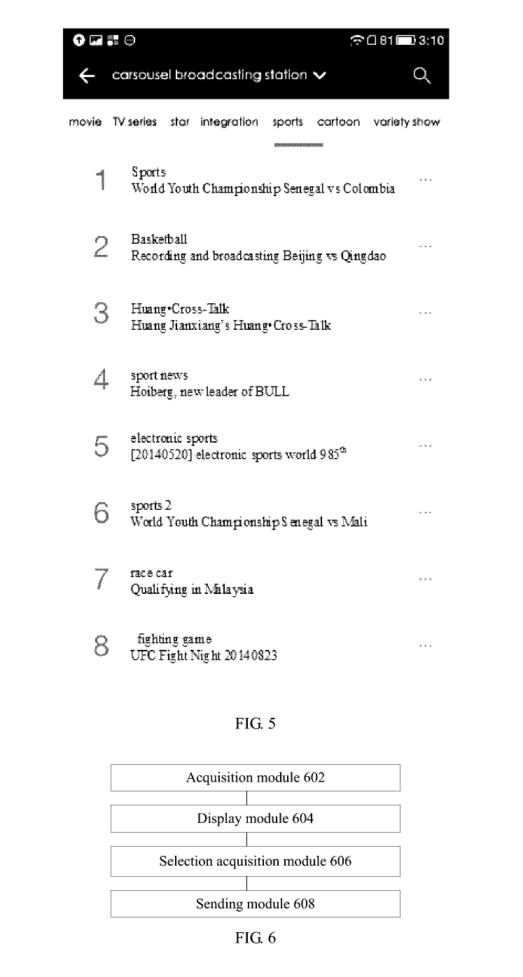

With reference to FIG. 6, which illustrates a structural block diagram of the device for controlling the program broadcasting of the television equipment according to an embodiment of the present disclosure, the device may specifically include the following modules: an acquisition module 602, a display module 604, a selection acquisition module 606 and a sending module 608.

The acquisition module 602 is configured to acquire a program list corresponding to a carousel-broadcasting program assembly from a server, wherein the carousel-broadcasting program assembly includes programs that are carousel-broadcast in a set time slot.

The display module 604 is configured to display the respective carousel-broadcasting programs in the carousel-broadcasting program assembly in categories according to the program list.

The selection acquisition module 606 is configured to acquire the carousel-broadcasting programs of the selected program category and program information of the carousel-broadcasting programs according to a first selection instruction.

The sending module 608 is configured to send the program information of the carousel-broadcasting programs to connected television equipment so as to control the television equipment to broadcast the carousel-broadcasting programs.

In conclusion, the program list corresponding to the carousel-broadcasting program assembly is acquired from the server through mobile equipment, the carousel-broadcasting programs are displayed in categories according to the program list, the carousel-broadcasting programs and the program information thereof in the designated category are acquired according to the first selection instruction, and the program information is sent to the connected television equipment so as to control the television equipment to broadcast the carousel-broadcasting programs, and therefore program selection operations are simplified, and control efficiency is increased.

The device is applied to the mobile equipment of a television control system, so that the mobile equipment controls the television equipment in the system to broadcast corresponding carousel-broadcasting programs.

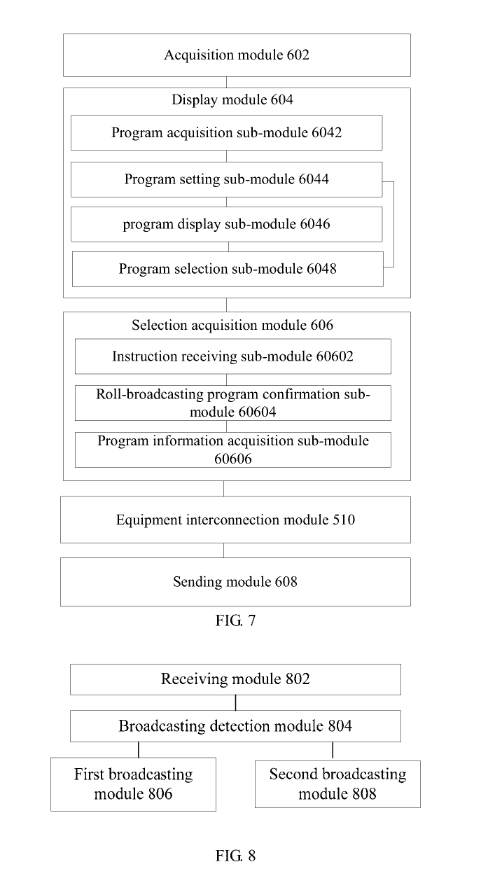

With reference to FIG. 7, which illustrates a structural block diagram of a device for controlling program broadcasting of television equipment according to another embodiment of the present disclosure, the device may include the following modules: an acquisition module 602, a display module 604, a selection acquisition module 606, an equipment interconnection module 610 and a sending module 608.

The acquisition module 602 is configured to acquire a program list corresponding to a carousel-broadcasting program assembly from a server, wherein the carousel-broadcasting program assembly includes programs that are carousel-broadcast in a set time slot.

The display module 604 is configured to display the respective carousel-broadcasting programs in the carousel-broadcasting program assembly in categories according to the program list.

According to an optional embodiment of the present disclosure, the display module 604 includes a program acquisition sub-module 6042, a program setting sub-module 6044 and a program display sub-module 6046, wherein,

the program acquisition sub-module 6042 is configured to acquire at least two program categories and the respective carousel-broadcasting programs corresponding to each program category from the program list;

the program setting sub-module 6044 is configured to display the respective program categories according to a preset order and arrange the respective carousel-broadcasting programs in the program categories that they belong to; and

the program display sub-module 6046 is configured to display the respective carousel-broadcasting programs corresponding to a default program category.

According to an optional embodiment of the present disclosure, the display module 604 may further include a program selection sub-module 6048.

The program selection sub-module 6048 is configured to receive a second selection instruction for the program categories to confirm a selected program category.

The program display sub-module 6046 is also configured to display the respective carousel-broadcasting programs corresponding to the selected program category.

The selection acquisition module 606 is configured to acquire the carousel-broadcasting programs of the selected program category and program information of the carousel-broadcasting programs according to a first selection instruction.

According to an optional embodiment of the present disclosure, the selection acquisition module 606 includes an instruction receiving sub-module 60602, a carousel-broadcasting program confirmation sub-module 60604 and a program information acquisition sub-module 60606, wherein:

the instruction receiving sub-module 60602 is configured to receive the first selection instruction for the carousel-broadcasting programs in the selected program category;

the carousel-broadcasting program confirmation sub-module 60604 is configured to acquire the selected program category and corresponding carousel-broadcasting programs from the first selection instruction; and

the program information acquisition sub-module 60606 is configured to acquire the program information of the carousel-broadcasting programs corresponding to the selected program category.

The equipment interconnection module 610 is configured to acquire a local area network list based on a terminal interconnection assembly and display other equipment in the local area network, wherein other equipment includes the television equipment, the television equipment is selected from the local area network list, and is registered in the terminal interconnection assembly to establish a connection of the television equipment and the mobile equipment.

The sending module 608 is configured to send the program information of the carousel-broadcasting programs to the connected television equipment to control the television equipment to broadcast the carousel-broadcasting programs.

On the basis of the above embodiment, the embodiment further provides a device for broadcasting programs of television equipment. The device is applied to the television equipment of a television control system so as to broadcast the carousel-broadcasting programs according to the control of mobile equipment.

With reference to FIG. 8, which illustrates a structural block diagram of a device for broadcasting the programs of the television equipment according to an embodiment of the present disclosure, the device may specifically include the following modules:

a receiving module 802, which is configured to receive program information of carousel-broadcasting programs that are sent from connected mobile equipment, wherein the program information is selected after mobile equipment displays a program list corresponding to a carousel-broadcasting program assembly in categories;

a broadcasting detection module 804, which is configured to determine whether to support a carousel-broadcasting station function;

a first broadcasting module 806, which is configured to broadcast the program information to a carousel-broadcasting station application for the broadcasting of the carousel-broadcasting programs when the carousel-broadcasting station function is supported; and

a second broadcasting module 808, which is configured to activate a player to broadcast the carousel-broadcasting programs corresponding to the program information when the carousel-broadcasting station function is not supported.

According to an optional embodiment of the present disclosure, the broadcasting detection module 804 is configured to determine whether a television supports the carousel-broadcasting station function by querying data in a database of a carousel-broadcasting station.

The receiving module 802 is configured to receive a first broadcasting message that is sent by the connected mobile equipment through a terminal interconnection assembly, wherein the first broadcasting message includes program information of the carousel-broadcasting programs.

The second broadcasting module 808 is configured to activate a player and send the program information to the player; the player confirms a broadcasting address according to the program information and acquires broadcasting data from the broadcasting address for the broadcasting of the carousel-broadcasting programs.

In conclusion, the program list corresponding to the carousel-broadcasting program assembly is acquired from the server through the mobile equipment, at least two program categories and the respective carousel-broadcasting programs corresponding to each program category are acquired from the program list, the respective program categories are displayed according to a preset order, the respective carousel-broadcasting programs are arranged in the program categories that they belong to for the convenience of the user to look for the favorite program, and therefore program selection operations are simplified, and control efficiency is increased.

Device embodiments are briefly described herein as they are substantially similar to method embodiments; please refer to the description of the method embodiments for associated parts.

All embodiments in the specifications are described in a progressive manner. Each embodiment focuses on describing the differences from other embodiments, and please refer to each other for identical or similar parts of the respective embodiments.

A person skilled in the art should understand that embodiments of the present disclosure may provide a method, a device or a computer program product. Therefore, a hardware-only embodiment, a software-only embodiment or a hardware-software combined embodiment may be employed in the present disclosure. Moreover, the embodiments of the present disclosure may employ a computer program product that is executed on one or more computer-available storage mediums (including but not limited to a magnetic disk memory, a CD-ROM (Compact Disc Read-Only Memory), an optical memory and the like) in which a computer-available program code is included.

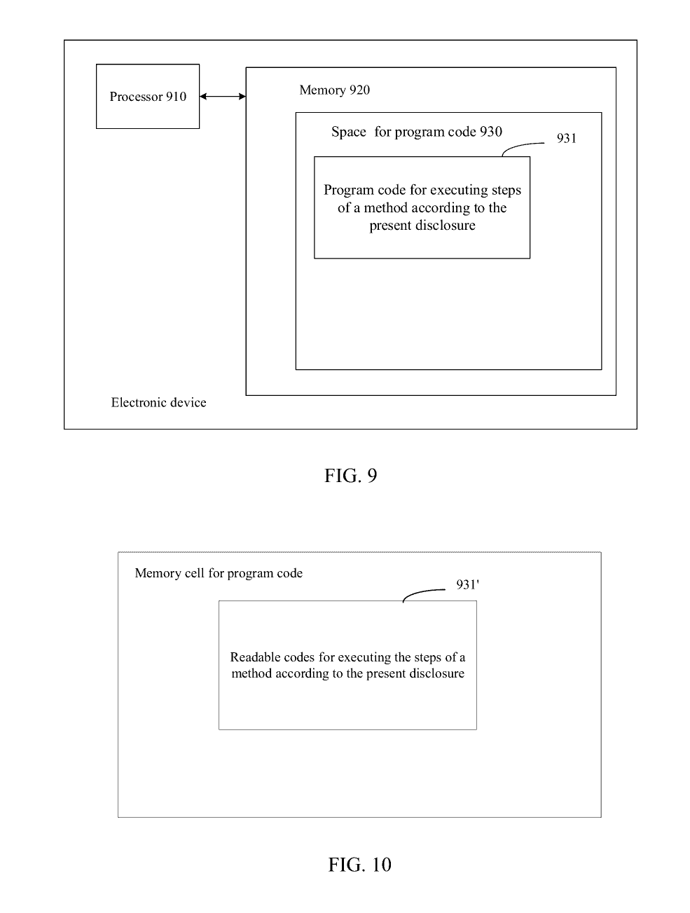

For example, FIG. 9 illustrates a block diagram of electronic device for executing the method according the disclosure, such as the mobile equipment or television equipment above. Traditionally, the electronic device includes a processor 910 and a computer program product or a computer readable medium in form of a memory 920. The memory 920 could be electronic memories such as flash memory, EEPROM (Electrically Erasable Programmable Read-Only Memory), EPROM, hard disk or ROM. The memory 920 has a memory space 930 for executing program codes 931 of any steps in the above methods. For example, the memory space 930 for program codes may include respective program codes 931 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 10. The memory cells may be provided with memory sections, memory spaces, etc., similar to the memory 920 of the electronic device as shown in FIG. 9. The program codes may be compressed for example in an appropriate form. Usually, the memory cell includes computer readable codes 931′ which can be read for example by processors 910. When these codes are operated on the electronic device, the electronic device may execute respective steps in the method as described above.

The embodiments of the present disclosure are described with reference to flow charts and/or block diagrams of a method, terminal equipment (system) and a computer program product according to the embodiment of the present disclosure. It should be understood that each flow and/or block in the flow charts and/or the block diagrams and the combination of flows and/or blocks in the flow charts and/or the block diagrams may be realized by computer program instructions. These computer program instructions may be provided to a general-purpose computer, a special-purpose computer, an embedded processor or other processors of programmable data processing terminal equipment to generate a machine, so that the instructions that are executed by the computers or other processors of the programmable data processing terminal equipment generate a device for realizing functions that are designated in one or more flows of the flow charts and/or one or more blocks of the block diagrams.

These computer program instructions may also be stored a computer readable storage that can guide a computer or other programmable data processing terminal equipment to work in a specific manner, so that the instructions that are stored in the computer readable storage generate a produce that includes an instructing device, and the instructing device can realize the functions that are designated in one or more flows of the flow charts and/or one or more blocks of the block diagrams.

These computer program instructions may also be loaded to a computer or other programmable data processing terminal equipment, so as to execute a series of operation steps on the computer or the other programmable data processing terminal equipment to generate computer-realized processing, and therefore the instructions that are executed on the computer or the other programmable data processing terminal equipment provide steps for realizing the functions that are designated in one or more flows of the flow charts and/or one or more blocks of the block diagrams.

Although the preferable embodiments of the present disclosure have been described, a person skilled in the art may change or amend these embodiments in case of learning about the basic concept of creativity. Therefore, the accompanying claims are explained on purpose to include all changes and amendments within the scope of the present disclosure.

Finally, it should be noted that: the relational terms in the present disclosure, such as first, second and the like, are only employed to distinguish one entity or an operation from another entity or operation, and do not always claim or imply that there is any such actual relation or order between these entities or operations. Moreover, the term “comprise”, “include” or any other variants thereof intends to cover non-exclusive inclusions, so that a process, a method, an article or terminal equipment including a series of elements not only includes the indicated elements but also includes other elements that are not listed explicitly or inherent elements for the process, method, article or terminal equipment. In case of no further limitation, an element that is defined by the term “including a . . . ” does not exclude that additional identical elements also exist in the process, method, article or terminal equipment including the element.

According to the present disclosure, the method for controlling the program broadcasting of the television equipment and the device for controlling the program broadcasting of the television equipment are described in detail. Principles and embodiments of the present disclosure are explained herein based on specific cases, the description on the embodiments is only for the assistance to understand the method and the core concept of the present disclosure, and meanwhile a person skilled in the art will change the embodiments and application scope based on the idea of the present disclosure. In conclusion, the content of the specifications should not be understood as a limitation to the present disclosure.

What is claimed is:

1. A method for controlling program broadcasting of television equipment, the method being applied to mobile equipment, wherein the method comprises:
acquiring by the mobile equipment a program list corresponding to a carousel-broadcasting program assembly from a server, wherein the carousel-broadcasting program assembly comprises programs that are carousel-broadcast in a set time slot;
displaying respective carousel-broadcasting programs in the carousel-broadcasting program assembly in categories according to the program list;
acquiring the carousel-broadcasting programs of a selected program category and program information of the carousel-broadcasting programs according to a first selection instruction; and
sending the program information of the carousel-broadcasting programs to connected television equipment so as to control the television equipment to broadcast the carousel-broadcasting programs.

2. The method according to claim 1, wherein displaying the respective carousel-broadcasting programs in the carousel-broadcasting program assembly in categories according to the program list comprises the following steps:
acquiring from the program list at least two program categories and the respective carousel-broadcasting programs corresponding to each category;
displaying the respective program categories according to a preset order and arranging the respective carousel-broadcasting programs in the program categories that they belong to; and
displaying the respective carousel-broadcasting programs corresponding to a default program category.

3. The method according to claim 2, wherein acquiring the carousel-broadcasting programs of the selected program category and the program information of the carousel-broadcasting programs according to the first selection instruction comprises the following steps:
receiving the first selection instruction for the carousel-broadcasting programs in the selected program category;
acquiring from the first selection instruction the selected program category and corresponding carousel-broadcasting programs; and
acquiring the program information of the carousel-broadcasting programs corresponding to the selected program category.

4. The method according to claim 3, wherein before acquiring the carousel-broadcasting programs of the selected program category and the program information of the carousel-broadcasting programs, the method further comprises:
receiving a second selection instruction for the program categories to confirm the selected program category; and
displaying the respective carousel-broadcasting programs corresponding to the selected program category.

5. The method according to claim 4, wherein before sending the program information of the carousel-broadcasting programs to the connected television equipment, the method further comprises:
acquiring by the mobile equipment a local area network list based on a terminal interconnection assembly, and displaying other equipment in the local area network, wherein the other equipment comprises the television equipment;
selecting the television equipment from the local area network list; and
registering the television equipment in the terminal interconnection assembly to establish a connection of the television equipment and the mobile equipment.

6. The method according to claim 1, wherein the program information comprises a program name, a broadcasting address and/or description information.

7. A method for controlling program broadcasting of television equipment, the method being applied to the television equipment, wherein the method comprises:
receiving program information of carousel-broadcasting programs that is sent by connected mobile equipment, wherein the program information is selected after the mobile equipment displays a program list corresponding to a carousel-broadcasting program assembly in categories;
determining whether to support a carousel-broadcasting station function according to the program information;
broadcasting the program information to a carousel-broadcasting station application for the broadcasting of the carousel-broadcasting programs when the carousel-broadcasting station function is supported; and
activating a player to broadcast the carousel-broadcasting programs corresponding to the program information when the carousel-broadcasting station function is not supported.

8. The method according to claim 7, wherein determining whether to support the carousel-broadcasting station function according to the program information comprises:
querying data in a data base of a carousel-broadcasting station according to the program information to determine whether to support the carousel-broadcasting station function.

9. The method according to claim 7, wherein receiving the program information of the carousel-broadcasting programs that is sent by the connected mobile equipment comprises:
receiving a first broadcasting message that is sent by the connected mobile equipment through a terminal interconnection assembly, wherein the first broadcasting message comprises the program information of the carousel-broadcasting programs.

10. The method according to claim 7, wherein activating the player to broadcast the carousel-broadcasting programs corresponding to the program information comprises:
activating the player and sending the program information to the player; and
confirming by the player a broadcasting address according to the program information and acquiring from the broadcasting address broadcasting data for the broadcasting of the carousel-broadcasting programs.

11. An electronic device for controlling program broadcasting of television equipment, comprising:
at least one first processor; and
a first memory communicably connected with the at least one first processor for storing instructions executable by the at least one first processor, wherein execution of the instructions by the at least one first processor causes the at least one first processor to:
acquire a program list corresponding to a carousel-broadcasting program assembly from a server, wherein the carousel-broadcasting program assembly comprises programs that are carousel-broadcast in a set time slot;
display respective carousel-broadcasting programs in the carousel-broadcasting program assembly in categories according to the program list;
acquire the carousel-broadcasting programs of a selected program category and program information of the carousel-broadcasting programs according to a first selection instruction; and
send the program information of the carousel-broadcasting programs to connected television equipment so as to control the television equipment to broadcast the carousel-broadcasting programs.

12. The electronic device according to claim 11, wherein display respective carousel-broadcasting programs in the carousel-broadcasting program assembly in categories according to the program list comprises:
acquire at least two program categories and the respective carousel-broadcasting programs corresponding to each program category from the program list;
display the respective program categories according to a preset order and arrange the respective carousel-broadcasting programs in the program categories that they belong to; and
display the respective carousel-broadcasting programs corresponding to a default program category.

13. The electronic device according to claim 12, wherein acquire the carousel-broadcasting programs of a selected program category and program information of the carousel-broadcasting programs according to a first selection instruction comprises:
receive the first selection instruction for the carousel-broadcasting programs in the selected program category;
acquire the selected program category and corresponding carousel-broadcasting programs from the first selection instruction; and
acquire the program information of the carousel-broadcasting programs corresponding to the selected program category.

14. The electronic device according to claim 13, wherein display respective carousel-broadcasting programs in the carousel-broadcasting program assembly in categories according to the program list comprises:
receive a second selection instruction for the program categories to confirm the selected program category; and
display the respective carousel-broadcasting programs corresponding to the selected program category.

15. The electronic device according to claim 14, wherein execution of the instructions by the at least one processor causes the at least one processor to further:
acquire a local area network list based on a terminal interconnection assembly and display other equipment in the local area network, wherein the other equipment comprises the television equipment, the television equipment is selected from the local area network list, and is registered in the terminal interconnection assembly to establish a connection of the television equipment and the electronic device.

16. The electronic device according to claim 11, wherein the program information comprises a program name, a broadcasting address and/or description information.

17. An electronic device for broadcasting programs, wherein the electronic device comprises:
at least one second processor; and
a second memory communicably connected with the at least one second processor for storing instructions executable by the at least one second processor, wherein execution of the instructions by the at least one second processor causes the at least one second processor to:
receive program information of carousel-broadcasting programs sent from connected mobile equipment, wherein the program information is selected after mobile equipment displays a program list corresponding to a carousel-broadcasting program assembly in categories;
determine whether to support a carousel-broadcasting station function;
broadcast the program information to a carousel-broadcasting station application for the broadcasting of the carousel-broadcasting programs when the carousel-broadcasting station function is supported; and
activate a player to broadcast the carousel-broadcasting programs corresponding to the program information when the carousel-broadcasting station function is not supported.

18. The electronic device according to claim 17, wherein: determine whether to support a carousel-broadcasting station function comprises: determine whether to support the carousel-broadcasting station function by querying data in a database of a carousel-broadcasting station.

19. The electronic device according to claim 17, wherein: receive program information of carousel-broadcasting programs sent from connected mobile equipment comprises: receive a first broadcasting message sent by the connected mobile equipment through a terminal interconnection assembly, wherein the first broadcasting message comprises the program information of the carousel-broadcasting programs.

20. The electronic device according to claim 17, wherein: activate a player to broadcast the carousel-broadcasting programs corresponding to the program information when the carousel-broadcasting station function is not supported comprises: activate a player and send the program information to the player; the player confirms a broadcasting address according to the program information and acquires broadcasting data from the broadcasting address for the broadcasting of the carousel-broadcasting programs.
